(19) United States
(12) Patent Application Publication
(10) Pub. No.: US 2005/0120600 A1
(43) Pub. Date: Jun. 9, 2005

(54) Marker for cups, system for distinguishing cups, and method for identifying a cup with a marker

(76) Inventor: James E. Harman, Fort Lauderdale, FL (US)

Correspondence Address: Loren Donald Pearson, P.A., P.O. Box 402571, Miami Beach, FL, 33140-2571, US

(21) Appl. No.: 10/989,825

(22) Filed: Nov. 16, 2004

Related U.S. Application Data
(63) Continuation-in-part of application No. 10/085,921, filed on Feb. 28, 2002, now Pat. No. 6,839,940.

(51) Int. Cl. G09F 3/00

(52) U.S. Cl. 40/324

(57) ABSTRACT

A marker identifies a cup from a group of otherwise identify cups. The marker encircles and completes the shape of the cup, particularly the base. Frustoconical-shaped markers are particularly useful for identifying frustoconical shaped cups (i.e. pint glasses). Advertising and other indicia can be added to the marker.

### CROSS-REFERENCE TO RELATED APPLICATION

This application is a Continuation-In-Part of U.S. patent application No. 10/085,921, filed on Feb. 28, 2002.

### BACKGROUND OF THE INVENTION

1. Field of the Invention

The invention further relates to markers for temporarily marking, identifying, and distinguishing cups, in particular, frustoconical-shaped pint-sized glasses.

2. Description of the Related Art

Mugs, cups, and glasses are typically made of glass because glass is easy to clean, does not carry any unpleasant odors, and is inexpensive to produce. However, glass is not the only material that can be used for mug production. Porcelain, ceramics, and plastic may also be used in the manufacture of mugs, cups, or glasses.

The conventional mugs that are presently available today are produced without any distinguishing markings and are clear in color. They are typically round or paneled and are provided with a curved handle. However, some mugs do not have handles.

Likewise, cups or drinking glasses that are used in pubs are typically sized to hold a pint of a liquid (i.e. beer). These pint-sized glasses have a frustoconical shape. FIG. 1 shows a cup or drinking glass 110 according to the prior art. The cup 110 has a frustoconical shaped wall 112 with a narrower end at the closed bottom 114. Typically, the glass 110 has a solid bottom 116. The bottom 114 has a bottom width 117. The top 119 has a top width 118. Traditionally, the cup 110 is sized to hold a pint of a beverage.

An individual mug, cup, or drinking glass belonging to a one drinker cannot be distinguished from another mug, cup, or drinking glass belonging to another drinker. Because bars and other businesses use identically shaped mugs, the drinker (i.e., the person drinking from the mug) cannot identify their mug, cup, or drinking glass when it is placed near other identical mugs, cups, or drinking glasses. As a result, when a plurality of glasses are left side by side, subsequently the drinker will not be able to identify their mug so they must either decide to get a new mug or risk sharing a mug.

### SUMMARY OF THE INVENTION

It is accordingly an object of the invention to provide a marker for cups, a system for distinguishing identical cups, and a method for identifying a cup with a marker that overcome the above-mentioned disadvantages of the heretofore-known devices and methods of this general type.

With the objects of the invention in view, there is provided a marker for identifying a cup having a cup wall. The marker includes a wall complementing the cup wall and configured to abut and encircle the cup wall. Unique indicia are disposed on said for distinguishing the mark from other markers.

For frustoconical shaped cups (i.e. pint glasses), the wall of the marker is frustoconical shaped to complements the cup wall. To provide the best fit between the marker and the cup, the slope (judged from vertical when the cup is resting on its bottom) of the marker wall equals the slope of the cup wall. To guarantee that the marker does not extend above the top or bottom edge of the cup, the diameter of the bottom edge is at least as large as the width of the bottom of the cup and the diameter of the top edge is at most as large as the width of the top of the cup.

In accordance with a further object of the invention, a placard can be connected to the wall of the marker. A label can then be placed on the placard.

In accordance with a further object of the invention, the indicia can be a color. The indicia can be molded in the wall or etched in the surface.

In accordance with a further object of the invention, the label can include adhesive for attaching the label to said placard. Alternatively, the label can be thermally bonded to the placard. The placard can have a groove formed therein and the label would be attached to the placard in the groove. The indicia or the label can be an advertisement, for example, for the seller or beverage manufacturer.

In accordance with a further object of the invention, the wall is a resilient plastic resin. By being a resilient plastic resin, in particular one of those listed above, the marker will have enough flexibility and strength to be shoved onto a cup and hold on the cup. In particular, the marker can be constructed from a thermoplastic. The thermoplastic can be formed according to any of the following methods: extrusion, thermoforming, vacuum forming, rotating molding, rotary molding, resin transfer molding, sandwich molding, injection stamping, blow molding-injection, blow molding-extrusion, injection molding, and reaction injection molding. The thermoplastic can be selected from the following: acetals, acrylics, actylonitrile-butadine-styrene, actylonitrile-butadine-styrene polycarbonate alloy, actylonitrile-chlorinated pe-styrene, actylonitrile-styrene-acrylic, actylonitrile-styrene-acrylic polycarbonate alloy, alkyd, allyis, ASA polycarbonate alloy, bismaleimide, cellulosics, cyanatester, epoxy resins, ethylene-acid copolymer, ethylene-ethyl acrylate, ethylene-methyl acrylate, ethylene-vinyl acutate, ethylene-vinyl alcohol, ethylene-vinyl silane copolymer, fluoropolymers, foam rubber, ionomer, ketone-based polymer, liquid-crystal polymers, melamine, urea, neoprene, phenolic, polyamide, polyamide-imide, polycrylate, methacrylate-butadiene-styrene, nitrile-butadiene copolymer, polyarylether, polybutadiene, polybutylene, polybutylene terephthalate, polycarbonate alloy, polycarbonate, polycyclohexylenemethylene-terephthalute, polyesters, unsaturated, polyethylene, high density, polyethylene, linear low, polyethylene, polyethylene, naphalate, polyetheylene terephthalate, polyimides, polymethylpentene, polymide, polyphenylene oxide, polyphenylene sulfide, polypropylene, polysobutylene, polysthylene, polystyrene, polytheremide, polyurethanes, polyvinyl acetate, polyvinyl alcohol, polyvinyl chloride flexible, polyvinyl rigid, pellets, polyvinyl rigid, powder, polyvinylidene chloride, silicone, styrene-acrylonitrile, styrene-butadiene copolymer, styrene-maelic anhydride, sulfone-based polymer, thermoplastic elastomers, and vinyl ester. The marker can be made by including a thermoplastic additive selected from the following group an acid scavenger, an adhesion promoter, an antifoaming agent, an antifogging agent, a antioxidant, an antiozonant, an antislip agent, an antistatic agent, an antitack agent, a bonding agent, a carbon black, a chain extender, a chelating agent, a complexing agent, a clarifying agent, a cling agent, a coloring agent, a defoamer, a deodorant, a desiccant, a dispersing agent, a emulsifier, a flattening agent, a fluorescent whitening agent, a fragrance, a fresh keeping agent, a gel inhibitor, a infra red filter, a inhibitor, a leveling agent, a matting agent, a gloss agent, a melt strength enhancer, a metal deactivator, a nucleating agent, a oxygen absorber, a peptizer, a photoinitiator, a polymerization inhibitor, a polymerization initiator, a release agent, a slip agent, a styrene suppressant, a tackifier, a thickening agent, a thixotropic agent, a titanium dioxide, a viscosity modifier, a wax, and a wetting agent.

The marker provides a platform for advertising and branding. The thermoplastic can be produced in any color, which will allow the user to distinguish their mug from others that may be in close proximity. The marker is constructed to releasably attach to any cup within a given size range. The flexible resilient nature of the thermoplastic will allow the marker to be used with at least some differently shaped cups.

The indicia can be three-dimensional and molded or sculpted on the marker. For example, a football or corporate loge could be added to the wall of the marker.

The marker can have indicia formed in the exterior surfaces to display a graphic or text message. This graphic or text message could be used in any way to convey a message, thought, or scene. The graphic or text message could be applied to the marker by any of the following application methods: thermal imprinting, pad printing, screen-printing, thermography, foil stamping, offset (lithography), gravure, foil stamping, engraving, shrink wrapping, printed sticker or adhesive, or any photo adhesion process.

In accordance with a further object of the invention, a marker fits around a cup wall of any cup, mug, or drinking glass. The marker includes a wide cylindrical substratum. The marker can extend beyond the bottom of the cup or act like a cuff around the cup. This substratum of the marker provides additional stability to the cup. Extending vertically up from the substratum and encompassing the entire exterior base of the mug would be the vertical wall of the marker. The wall of the marker preferably extends partially (for example, three-quarters of an inch (¾″)) up the exterior base of the mug and complements the increasing contour of the wall of the cup.

The marker can contain an indicia (e.g. a graphic, text message, placard, etching, or label) to be used in any way to promote the brand, mark, or corporate identity of any enterprise. The indicia could also be used for personal or business use by any entity—corporate, private, governmental, or other. The indicia can be affixed to the exterior surfaces of the marker and when attached to a cup, would be visible especially whenever out of the owner's grasp.

The marker's thermoplastic exterior can have a thermal label affixed to the thermoplastic. The thermal label containing information can be thermally welded (i.e. melded) into the thermoplastic or affixed with adhesive.

The marker's exterior surface can have an inlay or “groove” in the thermoplastic that encompasses the entire top exterior surface, leaving just the outer most edges at the original height. This inlay is about the approximate depth and an adhesive label/sticker. The label/sticker information stated would be affixed within the inlay borders with the height being consistent once the graphic is inlayed.

The marker's thermoplastic top exterior can remain a constant height and have the information printed on the thermoplastic using one of the early-described printing methods. Additionally, the entire marker's exterior can also have the information affixed, printed, etched, or formed thereon.

If thermoplastic is used, the thermoplastic can have color additives added so the marker can be formed using any available color. The thermoplastic can be formed using a solid color or multiple colors. The formed thermoplastic can use as many colors as needed to depict a certain blend or pattern, i.e. zebra stripes, polka dots, etc.

In accordance with a further object of the invention, a method identifies a given cup among a plurality of identical mugs. The method includes creating a marker to be unique compared to other makers, for example by marking the marker with its own color. The next step is to (releasably) attach the marker to the cup. The cup and marker thereby are uniquely identified from the other cups.

In accordance with a further object of the invention, a system for distinguishing two identical cups includes at least two markers as described above. The first marker has a first indicia. The second marker has a second, different indicia. By having different indicia, drinkers can distinguish their cup from other otherwise identical cups.

In accordance with a further object of the invention, a method for identifying a cup among a given number of identical cups is possible. In the first step of the method, a number of markers as described above are provided. The indicia of each of the markers is unique. The next step is attaching one of the markers to each of the cups. By doing so, each of the cups has a unique marker to help the drinker identify and distinguish their particular cup from otherwise identical cups. A possible additional step is sliding each of the markers onto a bottom of the respective cup; this is particularly useful with frustoconical-shaped cups (i.e. pint glasses).

Other features that are considered as characteristic for the invention are set forth in the appended claims.

Although the invention is illustrated and described herein as embodied in a marker for cups, a system for distinguishing cups, and a method for identifying a cup with a marker, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic front side view of a cup according to the prior art.

FIG. 2 is a diagrammatic front side view of a marker according to the invention attached to the cup.

FIG. 3 is a side perspective view of the marker.

FIG. 4 is a top side view of the marker.

FIG. 5 is a front side view of the marker.

### DESCRIPTION OF THE PREFERRED EMBODIMENTS

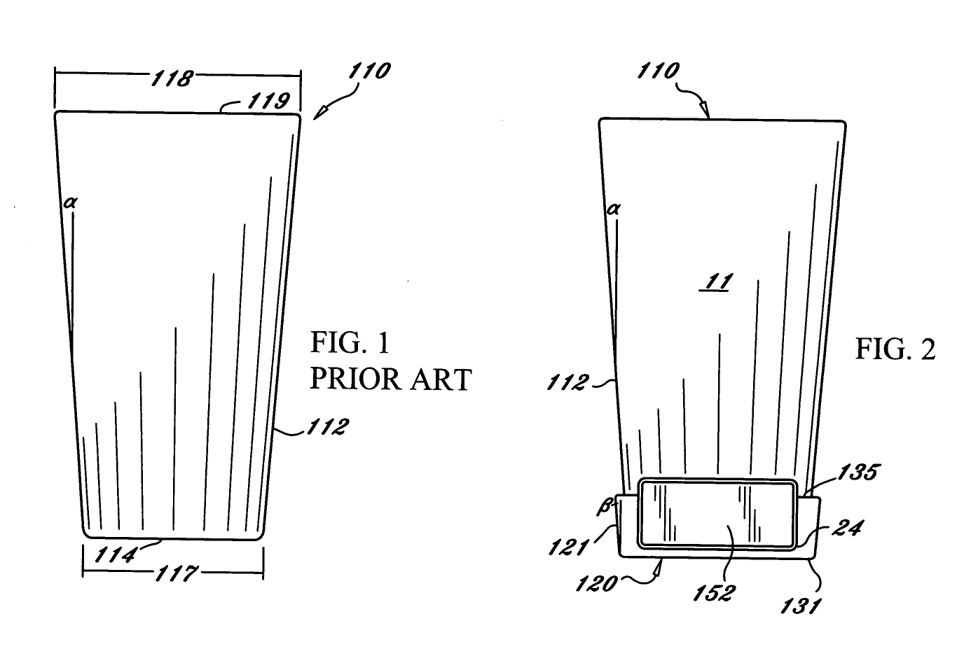

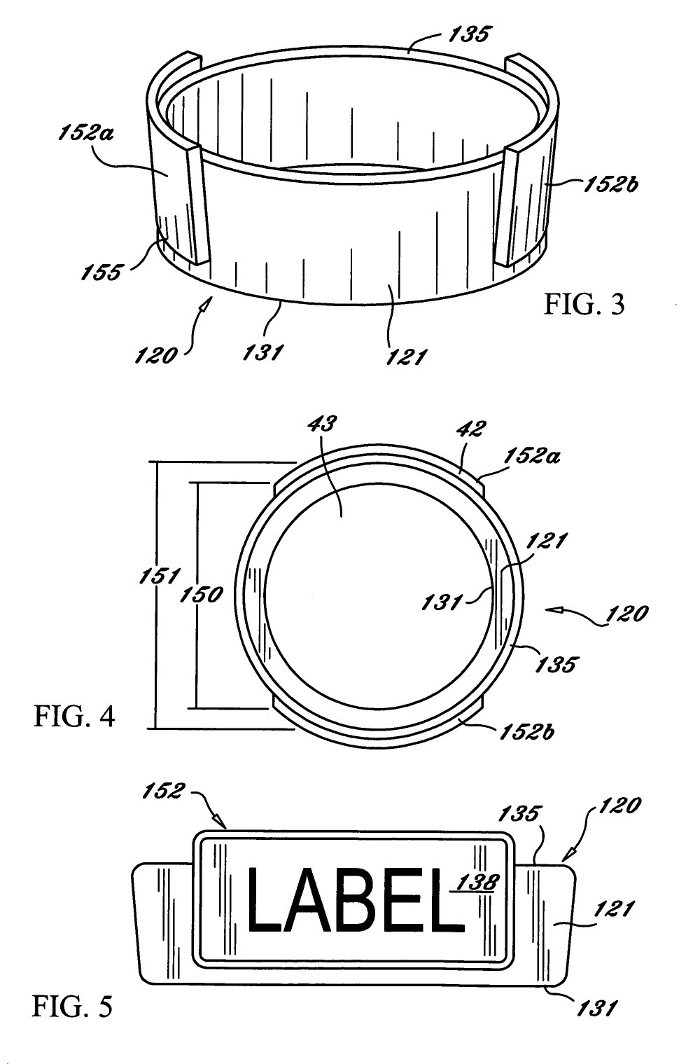

FIGS. 1-5 show a marker 120 for identifying and distinguishing a cup 110. The marker 120 has a wall 121 that encircles and abuts at least a portion of a cup wall 112.

A preferred embodiment of the marker 120 is to be used with a “pint glass”, which is common in the prior art. The pint glass is a frustoconical shaped cups 110 having a frustoconical-shaped wall 112 and a flat, horizontal base 114. The frustoconical-shaped wall 121 of the marker 120 complements the frustoconical cup wall 112 of the cup 110. As previously stated, the frustoconical wall 112 of the cup 110 has a slope α. The angle α is defined between the vertical to the base 114 and the cup wall 112. Likewise, in a preferred embodiment, the frustoconical wall 121 of the marker 120 has a slope β equaling the slope a of the cup 110. By having the slopes α, β equal each other, the marker 120 will fit snugly onto the cup 110. The marker 112 can be made by extruding a cylinder from thermoplastic and, subsequently, heat shaping the thermoplastic to from the slope β. Other angles are possible; the marker can be wedged onto the cup 112 due to its flexible resilient material.

As shown in FIG. 4, the wall 121 has a top edge 135 and a bottom edge 131. A small diameter 150 of the marker 120 is defined across the bottom edge 131. To fit the marker completely onto the cup 110, the small diameter 150 preferably at least equals the bottom width 117 of the cup 110. A large diameter 151 of the marker 120 is defined across the top edge 135. The large diameter 151 should be no larger than the top width 118 of the cup 110.

The marker 110 is preferably made of a resilient plastic material. Being resilient and plastic, the marker can be wedged onto the bottom of the cup 110. The force used to place the marker 110 combined with the resiliency of the material tends to hold the marker 110 on the cup 110.

The marker 110 includes indicia, preferably, in the form of different colors to help owners (i.e. drinkers) uniquely identify (at least within a given group of drinkers) which marker 120 and therefore which cup 110 is theirs. Other types of possible indicia include etchings (not illustrated) in the marker 120 or ornamental moldings (not illustrated).

In a preferred embodiment, the marker 110 includes a placard 152. The placard 152 can be formed integrally or bonded to the wall 121 of the marker 120. In a preferred embodiment, two placards 152a and 152b can be incorporated. The placard 152 has a label 138 placed thereon. As shown in FIG. 8, the placard 152 preferably includes a groove 155 in which the label 138 can be set. The label will can be an advertisement for a beverage, an event, or a seller. The marker 120 containing the label 138 can be sold or given away as a promotion.

To use the marker 120, a given number of drinkers use an equal number of unique markers 120 that are distinguished with different indicia (i.e. colors, labels, etc.). Thereby, the markers 110 uniquely identify the cups 110 that are attached, even if the cups 110 themselves are indistinguishable. To attach the markers 110, the marker 110 is slid over the bottom 116 of the cup 110 and gently forced so that the marker 110 will not slip from the cup 110.

1. A marker for identifying a cup having a cup wall, comprising:
a wall (121) complementing the cup wall and configured to abut and encircle the cup wall; and
indicia disposed on said wall for distinguishing the marker from other markers.

2. The marker according to claim 1, wherein:
the cup wall is frustoconical shaped; and
said wall is frustoconical shaped and complements the cup wall.

3. The marker according to claim 1, wherein:
the cup wall is frustoconical shaped with a slope; and
said wall is frustoconical shaped with a slope equaling the slope of the cup wall.

4. The marker according to claim 1, wherein:
the cup has a bottom with a bottom width and a top with a top width;
said wall has a bottom edge with a small diameter and a top edge with a large diameter;
said small diameter of said bottom edge is at least as large as the width of the bottom of the cup; and
said large diameter of said top edge is at most as large as the width of the top of the cup.

5. The marker according to claim 1, further comprising a placard connected to said wall.

6. The marker according to claim 5, further comprising a label on said placard.

7. The marker according to claim 1, wherein said indicia is a color.

8. The marker according to claim 1, wherein said indicia is molded in said wall.

9. The marker according to claim 1, wherein said indicia is etched in said surface.

10. The marker according to claim 6, wherein said label includes adhesive attaching said label to said placard.

11. The marker according to claim 6, wherein said label is thermally bonded to said placard.

12. The marker according to claim 6, wherein:
said placard has a groove formed therein; and
said label rests in said groove.

13. The marker according to claim 1, wherein said indicia is an advertisement.

14. The marker according to claim 6, wherein said label is an advertisement.

15. The marker according to claim 1, wherein said wall is a resilient plastic resin.

16. A system of markers for distinguishing two identical cups, comprising:
a first marker according to claim 1 having a first indicia for identifying a first of the two identical cups;
a second marker according to claim 1 having a second indicia different from said first indicia for identifying a second of the two identical cups.

17. A method for identifying a cup among a given number of identical cups, which comprises:
providing at least two markers according to claim 1, the indicia of each of the markers being unique; and
attaching one of the markers to each of the cups to uniquely identify the identical cups.

18. The method according to claim 17, which further comprises sliding each of the markers onto a bottom of the respective cup.
